(19) United States
(12) Patent Application Publication
(10) Pub. No.: US 2008/0201148 A1
(43) Pub. Date: Aug. 21, 2008

(54) SYSTEM AND METHOD FOR GENERATING AND USING AN ARRAY OF DYNAMIC GRAMMAR

(75) Inventor: Daniel Desrochers, Sainte-Julie (CA)

Correspondence Address: BROOKS KUSHMAN P.C., 1000 TOWN CENTER, TWENTY-SECOND FLOOR, SOUTHFIELD, MI, 48075, US

(73) Assignee: ADACEL, INC., Brossard (CA)

(21) Appl. No.: 11/675,338

(22) Filed: Feb. 15, 2007

(51) Int. Cl. G10L 15/00

(52) U.S. Cl. 704/257

(57) ABSTRACT

A system and method for generating dynamic grammars for use by a speech recognition system in response to signals from sensors indicative of the position and/or movement of a vehicle or platform, such as an aircraft or helicopter.

### BACKGROUND OF THE INVENTION

1. Field of the Invention

The invention relates to a system and method for generating dynamic grammars for use with a speech recognition system in response to signals from sensors indicative of the position and/or movement of a vehicle or platform, such as an aircraft or helicopter.

2. Background Art

A vehicle platform, such as an aircraft or helicopter, is capable of moving very quickly across a long distance at various altitudes. If a speech recognition system is used to assist in or respond to communications from the pilot or commander of the platform, then a large amount of information must be loaded into a database. Indeed, the database would become very large if it included data associated with all possible locations. Further, the database may include various homonyms: for example, there may be multiple entries in a database of airport names, waypoints, VORs, and the like that include a proper noun such as “Ford”. In such cases, it would be desirable to have a system that would isolate the irrelevant entries, and consider only those that are more relevant, depending upon an awareness of the platform's situation.

In the case of an aircraft, a pilot's real or virtual flight bag might include charts, approach plates, and various other media that might enable the pilot or electronic system to look up information on airports, runways, taxiways, waypoints, air traffic intersections, VORs, DMEs, cities, and prominent geographical locations (rivers, mountains, etc.), for example. For example, the pilot may say “Retrieve the standard terminal arrival route (‘STAR’) for runway 21R at DTW (‘Detroit Metropolitan Wayne County airport’).” The myriad of data elements must be recognizable with a very high degree of accuracy by a speech recognition system when spoken by the pilot.

Similar problems exist in other environments, such as in ships, automobiles, etc. (which may lack complications arising from a third dimension—altitude, although water depth may be vital information for the mariner). Adequate coverage would require very large databases, which in turn would be likely to reduce the performance and accuracy of a speech recognition system.

Since most geographical information is composed of spoken names (which include numbers in the context of runways, radio frequencies, etc.) rather than core grammar language, such geographical names or grammars normally would not be contained in a database of general speech grammars. For example, words such as “Dayton,” “Appleton,” “Scioto,” “Don Scott Field,” etc. are not used in general conversation without application to specific geographical areas or features, and therefore would not be contained in conversational or core grammars used in speech grammars that are normally accessed by a speech recognition system.

Since the computer memory allocated to storing and retrieving speech grammars being used by the speech recognition system is often limited, it is not feasible to load unlimited amounts of such geographical and context-sensitive information for all possible flight plans and geographical areas of the country. The resulting size and perplexity of a speech grammar database could cause the overall accuracy of a speech recognition system to degrade significantly—possibly reducing accuracy to an unusable level, such as 20%.

Therefore, without contextually-sensitive updates, or without the storage of large volumes of data and the use of a much higher performance processor, the utterance of commands by the pilot would not be recognized speedily by a conventional speech recognition system with the required high degree of accuracy.

A useful summary of the problems, benefits and issues arising from use of automated speech recognition systems in voice-activated cockpits appears in “VOICE ACTIVATED COCKPITS”, Gary M. Pearson, Adacel Systems, Inc. (2006). A copy of that paper is incorporated herein by reference.

### SUMMARY OF THE INVENTION

In one embodiment of the invention, a Situation Sensor (SS) detects a position (e.g., latitude, longitude, height) on the ground or in the air or in space and movement (e.g., speed, rate of change of speed) of a moving vehicle or platform and sends a signal to a Spoken Name Generator (SNG) (FIGS. 1-2). For example, the Situation Sensor may detect characterizing indicia of the platform's position: the altitude is 10,000 feet and the location is Grand Rapids, Mich. As to the platform's movement, the Situation Sensor may detect that the direction is 090° and speed is 200 knots.

In one aspect of the invention, the Situation Sensor may send a signal indicative of the platform's situation to the Spoken Name Generator. The Spoken Name Generator (SNG) then might request relevant geographic and aeronautical information from an Electronic Flight Bag. The geographic information may be exemplified by one or more data elements which indicate for instance that the highest terrain within a given distance of the platform is 600 feet MSL and the Minimum End Route Altitude (MEA) along the applicable Victor airway is 1500 feet. Additional or alternative geographic information may also specify what are the 6 closest airports to the aircraft's position. Aeronautical information retrieved from the Electronic Flight Bag might also include the location of an Airport Radar Service Area (ARSA) and specific information about a particular airport, such as the number, orientation and length of runways, and approach control, tower, ground and clearance radio frequencies.

Thus, in response to the Situation Sensor Signal, the Spoken Name Generator requests from the Electronic Flight Bag relevant geographical and/or aeronautical information representative of the surrounding area and features and items in a defined geographical area around the position of the vehicle from an Aeronautic Charting, Cartographic, or other similar database. Rather than manually selecting and loading such information based upon a designated flight plan, it is desirable to access the electronic version of a general (wide or terminal coverage area) Aeronautic Charting or Cartographic database. Such databases are generally available and are periodically updated and enhanced. They can be obtained from such providers as the Jeppeson Corporation of Alexandria, Va. and the National Ocean Service (NOS) of Silver Spring, Md. The databases of general Aeronautic Charting and/or Cartographic information are referenced herein as the “Electronic Flight Bag” (EFB). In effect, the Electronic Flight Bag is an electronic version of the kind of charts and approach plates that conventionally are contained in the flight bag that is carried onto an aircraft by a pilot. Typical information contained in the Electronic Flight Bag would include airports (names, altitudes, runways, taxiways, parking spaces, radio frequencies, approach and departure information), air navigation routes and waypoints, geographical information (cities, highways, rivers, lakes, mountains, etc.) and other similar information that would be of interest or helpful to a pilot. Based on the Situation Signal, the Spoken Name Generator sorts, interprets, and analyzes the relevant data based upon stored algorithms, e.g. an acronym converter that translates an acronym (e.g. “21L”) to a spoken name for the runway (“Two One Left”). The Spoken Name Generator also retrieves, sorts and interprets other contextual data—such as origination point, destination, and/or flight plan for the vehicle—for use in the Contextual Dynamic Grammars database. The Spoken Name Generator then uses such information to dynamically update a database or array of Contextual Dynamic Grammars (CDG). The Contextual Dynamic Grammars database is coupled to a Speech Recognition System (SRS) in order to improve its performance.

By loading only the data that is contextually relevant to the pilot depending on the platform's situation at the time, the overall size of the Contextual Dynamic Grammars database (as well as the required memory) utilized by the Speech Recognition System can be significantly reduced. Also, the invention significantly reduces the perplexity of the grammars and therefore improves the recognition accuracy of the Speech Recognition System. By updating the Contextual Dynamic Grammars database with new data, either periodically and/or based on the location and movement of the aircraft, among other variables, a high accuracy of the Speech Recognition System can be maintained throughout the entire range of vehicle movement.

The information in the Electronic Flight Bag could be contained on a computer-readable disk means for data storage (such as a compact disk, a memory stick, a floppy or hard disk) or solid state equivalent (SRAM or similar non-volatile memory) that would be updated periodically with new information. Typically, this Electronic Flight Bag would be removably coupled to the Speech Recognition System by the pilot prior to departure. In the alternative, a non-removable memory device could be permanently coupled to the Speech Recognition System and then electronically updated in situ, such as through a wireless network or similar remotely accessed communication system.

Preferably, the Speech Recognition System generates signals that are received by a subassembly associated with the platform. For example, the subassembly might be a navigation system, a power plant manager, and a system that controls flaps, air speed brakes, or landing gear, or missile deployment system.

As used herein, the terms “aircraft” and “vehicle” should be construed to include any moving platform, vehicle or object that is capable of guided motion. Non-limiting examples include a drone, a spacecraft, a rocket, a guided missile, a lunar lander, a helicopter, a marine vessel, and an automobile. The term “pilot” includes a pilot, co-pilot, flight engineer, a robot or other operator of the platform.

### BRIEF DESCRIPTION OF THE DRAWINGS

FIG. 1 is a state diagram that depicts the functional interrelationships between certain components of the invention;

FIG. 2 is a process flow diagram illustrating the main steps involved in practicing the present invention; and

FIG. 3 is an illustrative array of tables of categories of information and representative data that are contained therein.

### DETAILED DESCRIPTION OF THE PREFERRED EMBODIMENT(S)

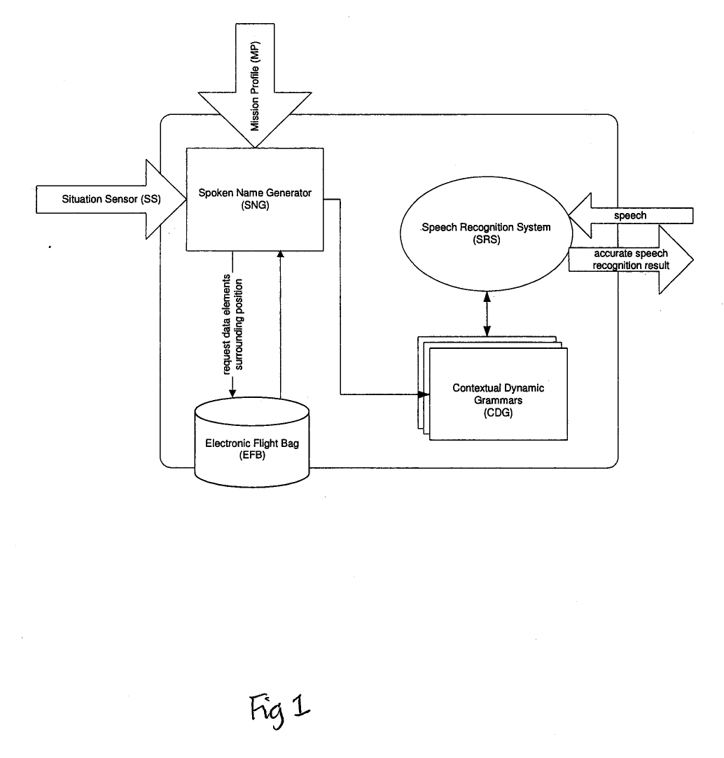

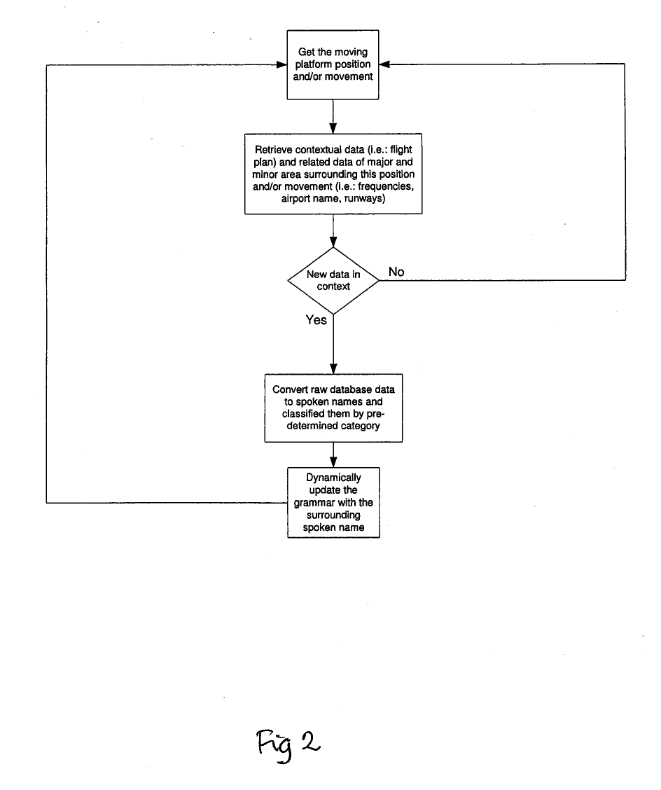

Generally stated, the invention in one aspect (FIGS. 1-2) includes interactions between a Situation Sensor, a Spoken Name Generator, an Electronic Flight Bag, a Contextual Dynamic Grammars database, and a Speech Recognition System that interfaces with a subassembly.

The following terms and acronyms are used in this disclosure and in the drawings:

1. SS—Situation Sensor;

2. SNG—Spoken Name Generator;

3. EFB—Electronic Flight Bag;

4. CDG—Contextual Dynamic Grammars database; and

5. SRS—Speech Recognition System.

In one embodiment, the subassembly with which the Speech Recognition System interfaces is exemplified by a communications or navigation radio, a flight director, or an autopilot in a moving platform such as an aircraft.

Initially, the Spoken Name Generator receives signals from the Situation Sensor. The signals include contextual data that are indicative of the position and speed of a moving platform. As mentioned earlier, in some embodiments, the Electronic Flight Bag contains more data in a first data array than are stored in the Contextual Dynamic Grammars database that is accessed by the Speech Recognition System. Accordingly, a Spoken Name Generator (SNG) is provided to dynamically select, interpret, analyze and sort through the first data array in the Electronic Flight Bag database and select (if desired, response to algorithms) only the data that are relevant to the pilot with respect to the present position, movement and flight plan for the aircraft.

Consider an aircraft on a taxiway at a departure airport. It is not particularly useful to have geographical information about the taxiways or instrument landing system for any random airport 1,000 km away loaded into the Contextual Dynamic Grammars database. Rather, the Electronic Flight Bag information relating to the departure airport, optionally as well as the departure and flight plan and destination airport, are much more relevant and more likely to be referenced and spoken by the pilot.

In context, the Speech Recognition System awaits speech or command signals that are either transmitted by or communicated verbally by a pilot or other operator of the platform. For example, the Speech Recognition System may await a command such as “Display the taxiway diagram for Detroit Metropolitan (or ‘Metro’) Airport.” Upon receiving the command, the Speech Recognition System compares the vocabulary used in the command with the vocabulary or data elements that are stored in a second data array preferably located in the Contextual Dynamic Grammars database with which the Speech Recognition System interfaces. The second data array is smaller than the first data array.

Clearly, the reliability or accuracy of speech recognition and its response time are favorably influenced by the reduced population of the data contained in the Contextual Dynamic Grammars database. If that database is replete with irrelevant data and/or contains superfluous homonyms, the Speech Recognition System would perform suboptimally. It is when the Speech Recognition System reliably recognizes the commands received from the pilot or operator and matches the elements of those commands with data elements contained in the Contextual Dynamic Grammars database that the Speech Recognition System may process the command. The processing step is initiated when a reasonable match is made between the command received and the data elements accessed by the Speech Recognition System. After a match is made, the Speech Recognition System may then interface with a subassembly by sending an activation signal thereto. In the previous example, the Speech Recognition System may cause to be displayed a runway diagram at Detroit Metropolitan Airport (DTW).

In order to facilitate a desired selection and sorting process, in one embodiment of the invention, the Spoken Name Generator is coupled to and receives position information from a platform position system (Situation Sensor—SS), such as a Global Positioning System (GPS) receiver, an inertial navigation system (INS), a LORAN positioning system, a VOR/DME or TACAN system, or other system that is capable of updating and generating a signal representing the position of the stationary or moving platform or aircraft. Preferably, the altitude of the moving platform preferably is also provided from the platform position system (e.g., directly from the GPS system, or optionally, calculated from GPS data), or from a barometric altimeter, radar altimeter, or other such system.

The Spoken Name Generator in some embodiments includes processor means for calculating or interpreting situation signals that represent such vectors as speed, direction, ascent/descent rate, heading, rate of change of heading, etc. Such calculations can be utilized to create trajectory estimates, flight plan tracking, and situational awareness for use in determining the optimum information to be selected from the Electronic Flight Bag by the Spoken Name Generator, as depicted schematically in FIG. 1.

In one embodiment, the Spoken Name Generator also is coupled to a Mission Profile database (“MP”, FIG. 1), which contains such data elements as flight plan data, aircraft data (type, identification, call sign, etc.), weather data, or personal information about the pilot and/or passengers. All data may change according to the context in which the aircraft is used or its mission. Specific information about the aircraft (such as the number of engines, the configuration of the avionics systems, etc.) could also be included in the Contextual Dynamic Grammars or other database illustrated as “MP”, if not already included in the Electronic Flight Bag.

In an optional embodiment, Mission Profile could be expanded to include information about systems (electronic and otherwise) contained in or accessible from the passenger compartment of the aircraft. In this manner, a passenger could be given access to a microphone coupled to the Speech Recognition System and could inquire about the present altitude of the aircraft, geographic points of interest along the flight path, the distance and time remaining to the destination airport, etc. In communication with the Mission Profile (wherever this database is located), the Speech Recognition System also could be used to activate an ancillary subsystem, such as an in-flight entertainment system (“Please play the movie ‘Gone with the Wind’ on the monitor”) or an air-to-ground communication system (“This is John Doe—please call my office”).

As mentioned earlier, in some embodiments, the Spoken Name Generator includes one or more means for retrieving information such as on one or more algorithms housed on data chips or logic cards or microprocessors and/or the like (collectively, “means” as used elsewhere herein, depending upon the context). In response to signals from the Situation Sensor indicative of the status and/or trend of positional information, the retrieval means retrieves and sorts through data in the Electronic Flight Bag. The Spoken Name Generator then selects information indicative of the current grammar that is likely to be required in contextual communication with the pilot or operator of the aircraft or vehicle, or in the case of an unmanned vehicle, a ground- or air-based operator.

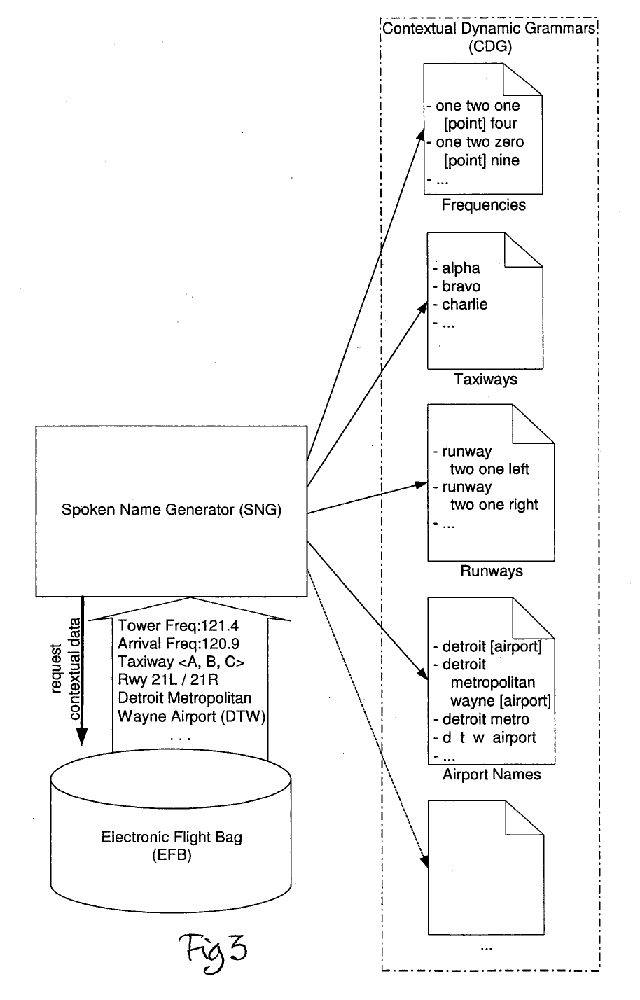

In one preferred embodiment (FIG. 3), this selected information typically is collected, sorted, interpreted and stored by category using one or more means for sorting. Categories could include subjects such as cities, rivers, air traffic control intersections and airports, among many others. The categories can also be subdivided further using one or more means for subdividing—for example, each airport could also include subcategories for radio frequencies, runways, taxiways, etc. This selected information is then converted using one or more means for translation in communication with the Spoken Name Generator into grammars of the appropriate language (e.g., English, Spanish, etc.) selected or used by the pilot.

At least some of the information in the Electronic Flight Bag could optionally be accessed directly using one or more means for direct access by the pilot (or possibly the passengers) through the Speech Recognition System. For example, the pilot may activate the Speech Recognition System and request that a map of the destination area—such as the Chicago metro area—be displayed on the navigation display or on a monitor in the passenger compartment of the aircraft. This process does not require extensive decoding of the grammar in the appropriate section of the Electronic Flight Bag, but merely a selection by the Spoken Name Generator of the map stored in the Electronic Flight Bag and then transferring that data to the navigation or other display system.

Thus, based on none or one or more algorithms, the Spoken Name Generator, in response to the status and/or trend of positional information (Situation Signal), retrieves, sorts and interprets relevant information from the Electronic Flight Bag. It then stores such relevant data in a Contextual Dynamic Grammars database. This Contextual Dynamic Grammars database would be chosen to be indicative of the current grammar likely to be required in contextual communication with the pilot of the vehicle.

By limiting the grammars stored for use by the Speech Recognition System to those words or data that could be reasonably predicted to be used by the pilot based upon the present position and/or condition of the aircraft (“situation”), the perplexity of the grammar is significantly reduced—which in turn increases the accuracy and decreases the response time of the Speech Recognition System.

One mode of basic operation of the present invention may be explained as follows. If the aircraft is moving slowly down a taxiway at a departure airport, then one or more Situation Sensors would sense its current position, relatively slow speed, and relatively constant altitude. In response, algorithm(s) would select and collect Mission Profile data. Such data may include flight plan and departure clearance data, as well as aeronautic charting information from the Electronic Flight Bag (e.g., taxiway information, taxiway intersections, airport runway information, departure pattern information, and appropriate radio frequency information—e.g., ground, tower, approach and departure communications frequencies, standard instrument departure (SID) procedures, etc.). Based upon priority selection criteria, the most relevant categories of this information would be selected by the Spoken Name Generator and sent to the Contextual Dynamic Grammars database for storage and subsequent retrieval by the Speech Recognition System.

Preferably, algorithms in the Spoken Name Generator also would sense when position, speed and altitude information indicate that the aircraft is flying at cruise speed and altitude in a direction from the departure airport and toward the destination airport. In this case, part of the Mission Profile data for aircraft taxiing and the departure airport would no longer be relevant, and would be deselected using one or more means for de-selection by the Spoken Name Generator. Correspondingly, after landing and roll out, the one or more means for de-selection excise from consideration information that otherwise would have been relevant to the en route portion of the flight, retaining instead the relevant indicia of the airport or other facility at which the landing has occurred.

More relevant information would be retrieved for the en-route flight, such as all significant towns, cities, geographical features (rivers, mountains, etc.), no-fly zones, and prohibited or restricted areas within a first radius that is dynamically determined by means for determining a radial distance from the current position of the aircraft. The dynamically determined radius could be calculated as a function of the altitude, speed, and type of aircraft, etc. For example, such a dynamically determined radius would be wider for a jet aircraft flying at 400 mph and 35,000 feet altitude, as compared to a single engine light aircraft flying at 120 mph and 8,000 feet altitude.

Also selected as relevant might be all airports and air navigation intersections within another second predetermined radius (either dynamically or statically determined) of the present position (such as 50 km radius), as well as information about radio frequencies and navigation aids (VOR, DME, TACAN, etc.) within a larger radius corresponding to the radio horizon from the present aircraft altitude. Preferably, the relevant data points within these radii would be updated or refreshed by one or more means for refreshing as a function of time while the aircraft progresses along its flight path. As a continuation of the previous example, in another embodiment, the algorithms or means for refreshing would categorize, prioritize and then download the relevant information and data about geographic points, cities airports, navigational aids, etc. along the flight path and ahead of the present position of the aircraft, as well as corresponding information in the vicinity of the destination airport.

In one preferred embodiment, the Spoken Name Generator may include means for periodically selecting between the multiple, e.g., two sources of data. But selection of data from the Electronic Flight Bag likely would occur more frequently than selection from another source, such as the Contextual Dynamic Grammars database. The time between updates to be accessed by the Spoken Name Generator may be determined in response to the speed, direction, change in direction, altitude, change in altitude, and other characterizations of the dynamics of the moving platform. For example, the data accessed by the Spoken Name Generator might be updated every 3 minutes when the aircraft is cruising at a 30,000 feet, but updated every 1 minute when descending from cruise altitude or after executing a maneuver that resulted in significant change in direction.

Such data also could be updated automatically by one or more means for updating in response to a change in status of the aircraft systems, e.g., a change in aircraft configuration from take off mode to a climb configuration (e.g., when the landing gear is retracted). Functional performance capabilities preferably would require that the Spoken Name Generator be coupled to a communications bus containing status or operational data from other aircraft systems. Information on the type of aircraft, together with its nominal performance parameters, may be obtained from the Mission Profile, Electronic Flight Bag or the Contextual Dynamic Grammars database. In response, one or more algorithms controlling the Spoken Name Generator may include such grammars to further enhance the performance of the Speech Recognition System.

As the aircraft begins to descend from its cruising flight level, a lower altitude could in one embodiment also trigger another algorithm to begin loading additional data for the destination airport and any significant Standard Terminal Arrival (STAR) procedures, navigational waypoints and approach information in the line of flight.

After the Spoken Name Generator uses these algorithms to select the relevant data from the Electronic Flight Bag and the Contextual Dynamic Grammars database, the information/grammar preferably is transferred by one or more means for transferring to a dynamic memory section of the Contextual Dynamic Grammars database which is accessed by the Speech Recognition System.

A preferred embodiment of the Speech Recognition System might include the DynaSpeak® model from Stanford Research Institute (SRI) of Menlo Park, Calif., or the ASR (Automatic Speech Recognition) or OSR (Open Speech Recognizer) models sold by NUANCE Corp. of Burlington, Mass. Such speech recognition systems operate on a general purpose microprocessor (such as an Intel Pentium processor) under the control of operating systems such as Microsoft Windows, or LINUX, or another real time operating system.

The DynaSpeak® speech recognition system, for example, already services selected aviation voice-activated cockpit and mission specialist applications. It is a speaker-independent speech recognition engine that scales from large to embedded applications in industrial, consumer, and military products and systems. DynaSpeak® incorporates techniques that are said to yield accurate speech recognition, computational efficiency, and robustness in high-noise environments.

Thus, the disclosed invention, in one embodiment, integrates DynaSpeak® (or a comparable system) into aviation applications developed for pilots, crew members, mission specialists, and unmanned aerial vehicle (UAV) operators. The integration enables these individuals to use speech recognition as an alternative interface with subassemblies such as displays, databases, communications, and command and control systems. By using voice commands, both flight personnel and specialists can configure instrumentation, navigation, database, and other operational flight deck and aircraft functions. Allowing flight crew members and specialists the option of using voice commands to control specific functions of their aircraft and its systems is expected to provide a safer, faster way for a pilot, for example, to accomplish his mission.

The total memory used for storage of speech elements in the Contextual Dynamic Grammars database and the Speech Recognition System may include a relatively static grammar memory (which includes grammar that is typically not sensitive to context (such as Core Grammars—everything other than the Spoken Name Generator grammar), and relatively dynamic grammar memory (which includes grammars from the Spoken Name Generator). The relative size of the static/dynamic memory allocation also could be adjusted or controlled by the Spoken Name Generator or a microprocessor controlling the Speech Recognition System.

By fine-tuning the previously described algorithms in the Spoken Name Generator, the scope or size of the grammar generated by the Spoken Name Generator and stored in the dynamic grammar storage can be reduced to only those contextual data that could be expected to be used by the pilot under the prevailing circumstances. This strategy minimizes memory storage and processor power requirements, while at the same time reducing the perplexity and improving the performance of the Speech Recognition System.

One preferred embodiment of the Speech Recognition System can be characterized as having a 98% word recognition accuracy. This engine is capable of producing a command recognition accuracy (typical goal) of approximately 19 out of 20 commands. (All performance data are approximate and are observed under normal operating conditions.) Without the use of the Contextual Dynamic Grammars database as described in the present invention, command accuracy could deteriorate into the 30-50% range. This is because context-sensitive grammar is not normally available to the Speech Recognition System, or the perplexity of the stored grammar is too high and the Speech Recognition System is unable to distinguish between similar words spoken by the pilot.

When the present invention is utilized, the dynamically selected grammar from the Electronic Flight Bag and the contextual data stored in the Contextual Dynamic Grammars database allow the Speech Recognition System to approach the 19 out of 20 command phrase recognition accuracy goal.

Other examples of environments in which the present invention can be used are illustrated by cases in which the moving vehicle or platform is an unmanned aerial vehicle (UAV). UAV control stations feature multiple menu pages with systems that are accessed by keyboard presses. Use of speech-based input may enable operators to navigate through menus and select options more quickly.

The utility of conventional manual input versus speech input has been experimentally examined. Observations have been made of tasks performed by operators of a UAV control station simulator at two levels of mission difficulty. In one series of experiments, pilots or operators performed a continuous flight/navigational control task while completing eight different data entry task types with each input modality. Results showed that speech input was significantly better than manual input in terms of task completion time, task accuracy, flight/navigation measures, and pilot ratings. Across tasks, data entry time was reduced by approximately 40% with speech input.

Here are illustrative results:

| | Number of Steps | | | Mean Completion | | |
|---|---|---|---|---|---|---|
| | to Complete | | | Time (Seconds) | | |
| | Manual/ | | | Speech/Manual/ | | |
| Task | Speech/Manual | | | Percent Savings | | |
| Level Off | 23 | 6 | 56.17 | 34.74 | 21.43 | 38.15 |
| Checklist | | | | | | |
| Emergency | 10 | 2 | 23.55 | 13.5 | 10.05 | 42.67 |
| Waypoint | | | | | | |
| Datalink Board | 31 | 23 | 20.76 | 11.16 | 9.6 | 46.24 |
| Overheat | | | | | | |
| Icing | 25 | 7 | 44.12 | 30.45 | 13.67 | 30.98 |

Thus, certain advantages of a reliable voice-controlled UAV station emerge:
Control more UAV's
Better situational awareness
Better safety checks and checklist management
Reduction in data input errors** ** USAFRL Study: Manual Versus Speech Input for Unmanned Air Vehicle Control Station Operations (2003).
Faster training time and no pilot requirement
Productivity increase and cost savings for rehearsal, training and operational missions
Single operator control functions of both pilot and payload specialist
Increase in operator standardization.

Thus, in one aspect, the present invention helps the crew of any flight get from point A to point B safely and economically. Aided by the Speech Recognition System, a voice-activated cockpit environment may allow the operator or pilot to directly access most system functions, even while he maintains hands-on control of the aircraft. Safety and efficiency benefits follow by elimination of the “middle man” of button pushers; direct aircraft system inquiries; oral data entry for flight management systems, autopilot, radio frequencies; correlation of unfamiliar local data; Electronic Flight Bag interaction; checklist assistance; leveling and/or heading bust monitoring; and memo creation.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for dynamically generating a contextual database that is accessed by a speech recognition system which interfaces with a subassembly of a vehicle, the system comprising:
a situation sensor that generates one or more signals indicative of the situation of the vehicle, the one or more signals including contextual data that are indicative of the position and speed of the vehicle;
a spoken name generator that receives the one or more signals from the situation sensor;
an electronic flight bag having a first data array, the spoken name generator dynamically accessing, interpreting, analyzing and sorting through the first data array in the electronic flight bag and selecting only the data that are relevant to a pilot with respect to the present position, movement and flight plan for the aircraft;
a contextual dynamic grammars database that includes a second data array which is smaller than the first data array; and
a speech recognition system that interfaces with the contextual dynamic grammars database and awaits one or more commands from a pilot or other operator of the vehicle before generating and sending one or more activation signals to the subassembly, so that upon receiving the one or more commands, the speech recognition system compares the vocabulary used in the one or more commands with data elements that are stored in the second data array in the contextual dynamic grammars database and when the speech recognition system reliably recognizes the one or more commands received from the pilot or other operator and matches them with data elements contained in the contextual dynamic grammars database, the speech recognition system processes the command by communicating the one or more activation signals to the subassembly.

2. The system of claim 1, wherein the spoken name generator includes one or more algorithms that assist in selecting the relevant data from the electronic flight bag.

3. The system of claim 1, wherein the one or more commands received from the pilot or other operator are communicated by a mode selected from the group consisting of oral speech and one or more electronic signals, and combinations thereof.

4. The system of claim 1 wherein the situation sensor detects position information from a platform position system selected from the group consisting of a global positioning system (GPS), an inertial navigation system (INS), a LORAN positioning system, a VOR/DME or TACAN system, a barometric altimeter, a radar altimeter, any other system that is capable of generating and updating one or more signals representing the position of the vehicles, and combinations thereof.

5. The system of claim 1 wherein the spoken name generator includes processor means for interpreting situation signals relayed by the situation sensor, the contextual data including one or more of signals indicative of such vectors as speed, direction, ascent/descent rate, heading and rate of change of heading for creating trajectory estimates and flight plan tracking for use in determining relevant information to be selected from the electronic flight bag by the spoken name generator.

6. The system of claim 1 wherein the spoken name generator is coupled to a mission profile database, the mission profile database including data elements selected from the group consisting of flight plan data, aircraft data, aircraft type, aircraft identification, number of engines, configuration of the avionics systems, weather data, and identifications of the pilot and passengers.

7. The system of claim 6 wherein the mission profile database includes information about systems associated with a passenger compartment of the vehicle so that a passenger is given access to a voice activated means coupled to the speech recognition system, the passenger being able to inquire about indicia selected from the group consisting of the altitude of the aircraft, geographic points of interest along the flight path, the distance and time remaining to the destination.

8. The system of claim 6 wherein the mission profile database interfaces with the speech recognition system so that an ancillary subsystem is activated, the ancillary subsystem being selected from the group consisting of an in-flight entertainment system, an air-to-ground communication system and combinations thereof.

9. The system of claim 1, wherein the spoken name generator includes means for retrieving information from the electronic flight bag in response to signals from the situation sensor indicative of the status and/or trend of positional information, the information being indicative of the current grammar that is likely to be required in contextual communication with the operator of the vehicle.

10. The system of claim 9, further including means for sorting the selected information by category, the category being selected from the group consisting of cities, rivers, air traffic control intersections and airports.

11. The system of claim 10, also including means for subdividing the categories into subdivisions, the subdivisions for an airport being selected from the group consisting of radio frequencies, runways, taxiways and VOR checkpoints.

12. The system of claim 10, also including means for translation, whereby selected information is converted by the spoken name generator into an appropriate language selected or used by the pilot.

13. The system of claim 1, further including means for direct access, the means for direct access enabling at least some of the information in the electronic flight bag to be accessed by a vehicle occupant through the speech recognition system so that decoding of the grammar in an appropriate section of the electronic flight bag is obviated.

14. The system of claim 6, further including means associated with the spoken name generator for de-selection of data in the mission profile database so that the spoken name generator senses when situation signals communicate that the aircraft is en route based on its position, speed and altitude so that mission profile data for aircraft taxiing and the departure airport are deselected.

15. The system of claim 6, further including means associated with the spoken name generator for de-selection of data in the mission profile database so that the spoken name generator senses when situation signals communicate that the aircraft has landed based on its position, speed and altitude so that mission profile data for an en route phase of flight is deselected.

16. The system of claim 12, further including means for retrieving more relevant information for an en-route portion of a flight, the more relevant retrieval means being selected from the group consisting of towns, cities, geographical features, rivers, mountains, no-fly zones, prohibited areas, and restricted areas.

17. The system of claim 13, further including means for determining a first radial distance from a current position of the aircraft.

18. The system of claim 17, further including means for determining the first radial distance based on altitude, speed and aircraft type, the means for retrieving thereby selecting all airports and air navigation intersections within the radial distance and radio frequencies and navigation aids (VOR, DME, TACAN, etc.) within a second larger radius corresponding to a radio horizon that is a function of aircraft altitude.

19. The system of claim 18, further including means for updating, the means for updating information about relevant data points within the radial distances as the aircraft progresses.

20. The system of claim 19, wherein the spoken name generator includes means for periodically selecting between the multiple sources of data, the multiple sources including the electronic flight bag and the contextual dynamic grammars database, wherein selection from the former occurs more frequently than selection from the latter.

21. The system of claim 20, wherein the time between updates by the spoken name generator is determined as a function of speed, direction, change in direction, altitude, change in altitude, and other vectors that characterize the dynamics of the moving vehicle.

22. The system of claim 21, further including means for updating in response to a change in status of the aircraft systems.

23. The system of claim 22, wherein the spoken name generator is coupled to a communications bus containing status or operational data from other aircraft systems.

24. The system of claim 23, further including means for transferring the relevant data to a dynamic memory section of the contextual dynamic grammars database for access by the speech recognition system.

25. A method for dynamically generating a contextual database that is accessed by a speech recognition system which interfaces with a subassembly of a vehicle, the method comprising the steps of:
providing a situation sensor that generates one or more signals indicative of the situation of the vehicle;
coupling a spoken name generator with the situation sensor;
linking an electronic flight bag to the spoken name generator;
providing a contextual dynamic grammars database in communication with the spoken name generator;
communicating a speech recognition system with the contextual dynamic grammars database; and
sending a signal from the speech recognition system to a vehicle subassembly when there is a match between a command initiated by a vehicle operator and a data element stored in the contextual dynamic grammars database.
